(19) United States
(12) Patent Application Publication
(10) Pub. No.: US 2016/0196029 A1
(43) Pub. Date: Jul. 7, 2016

(54) GAME SYSTEM FOR PROVIDING RHYTHM GAME SERVICE AND METHOD THEREFOR

(71) Applicant: LINE Plus Corporation, Seongnam-si (KR)

(72) Inventor: Byeong Yong OH, Seongnam-si (KR)

(21) Appl. No.: 14/837,312

(22) Filed: Aug. 27, 2015

(30) Foreign Application Priority Data
Jan. 6, 2015 (KR) 10-2015-0001158

(51) Int. Cl. G06F 3/0488

(52) U.S. Cl. CPC G06F 3/0488

(57) ABSTRACT

A game system for providing a rhythm game service and a method therefor are provided. The game method includes displaying an input interface, in which at least one of a size or a direction is adjusted according to an input of a user, on a screen of the computer; moving a note or note line towards a determination region; and determining success or accuracy in the input of the user according to a size or a direction of the input interface when the note or note line passes through the determination region.

### CROSS-REFERENCE TO RELATED APPLICATIONS

A claim for priority under 35 U.S.C. § 119 is made to Korean Patent Application No. 10-2015-0001158 filed Jan. 6, 2015, in the Korean Intellectual Property Office, the entire contents of which are hereby incorporated by reference.

### BACKGROUND

Embodiments of the inventive concepts described herein relate to a game system for providing a rhythm game service and/or a method therefor.

A rhythm game is an action game using a sense of rhythm of a player and is referred to as a music game or a rhythm action game. This rhythm game requests a user to perform a specific operation at accurate timing. A type of the operation of the user and accuracy of the operation performed by him or her are displayed on a screen.

### SUMMARY

Some embodiments of the inventive concepts provide a game system for providing a rhythm game service in such a way as to compare an adjusted size or direction of an input interface with a width of a note or note line or a location where the note or note line passes through a determination region when a user adjusts the size or direction of the input interface in response to the note or note line in which the width or the location where passing through the determination region is changed and a method therefor.

One aspect of embodiments of the inventive concepts is directed to provide a game method in a game system implemented with a computer. The game method may include controlling a screen to display an input interface, in which at least one of a size or a direction is adjusted according to an input of a user, on the screen of the computer, moving a note or note line towards a determination region on the screen, and determining success or accuracy in the input of the user according to a size or a direction of the input interface when the note or note line passes through the determination region.

Another aspect of embodiments of the inventive concepts is directed to provide a game system implemented with a computer. The game system may include a memory having computer readable instructions stored thereon and at least one processor configured to execute the computer readable instructions to control a screen to display an input interface, in which at least one of a size or a direction is adjusted according to an input of a user, on the screen of the computer, move a note or note line towards a determination region on the screen, and determine success or accuracy in the input of the user according to a size or a direction of the input interface when the note or note line passes through the determination region.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIGS. 1 to 4 are drawings illustrating a game screen for displaying a game process which proceeds by controlling a size of an input interface according to an example embodiment of the inventive concepts;

FIGS. 5 to 7 are drawings illustrating a game screen for displaying a game process which proceeds by controlling a direction of an input interface according to an example embodiment of the inventive concepts;

FIG. 8 is a flowchart illustrating an operation of a game method according to an example embodiment of the inventive concepts; and

FIG. 9 is a block diagram illustrating a configuration of a game system according to an example embodiment of the inventive concepts.

### DETAILED DESCRIPTION

Embodiments will be described in detail with reference to the accompanying drawings. The inventive concepts, however, may be embodied in various different forms, and should not be construed as being limited only to the illustrated embodiments. Rather, these embodiments are provided as examples so that this disclosure will be thorough and complete, and will fully convey the concepts of the inventive concepts to those skilled in the art. Accordingly, known processes, elements, and techniques are not described with respect to some of the embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “example” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concepts belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, a description will be given in detail for some example embodiments of the inventive concepts with reference to the accompanying drawings.

Embodiments of the inventive concepts relates to a game system for providing a new rhythm game service and/or a method therefor.

According to the rhythm game service described below according to various embodiments of the inventive concepts, users may enjoy games by adjusting a size or direction of each of a plurality of input interfaces in a slide or jog shuttle way while listening to music. Therefore, the game system may provide experience, as if a user becomes a disc jockey (DJ) who performs equalizing, to the user.

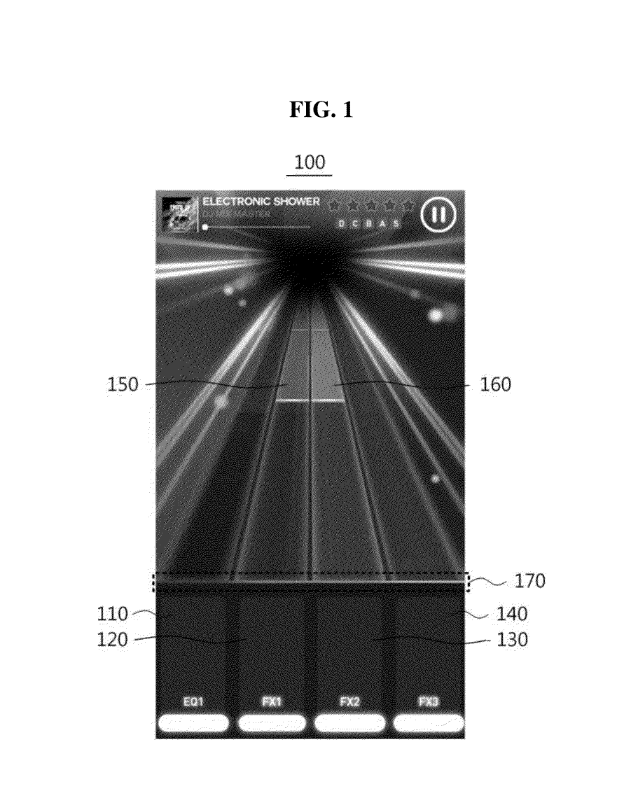

FIGS. 1 to 4 are drawings illustrating a game screen for displaying a game process which proceeds by controlling a size of an input interface according to an example embodiment of the inventive concepts.

A game screen 100 of FIG. 1 is an example of a screen on which a rhythm game service is provided. The game screen 100 may display four input interfaces 110 to 140 for four tracks, two note lines 150 and 160 which are moving through two tracks, and a determination region 170 indicated by a dotted line.

For example, a game system may display an input interface (e.g., the four input interfaces 110 to 140), in which at least one of a size and a direction is adjusted according to an input of a user, on the game screen 100. Also, the game system may move a note or note line (e.g., the two note lines 150 and 160) towards the determination region 170.

When the two note lines pass through the determination region 170, the user may control the two input interfaces 120 and 130 among the four input interfaces 110 to 140.

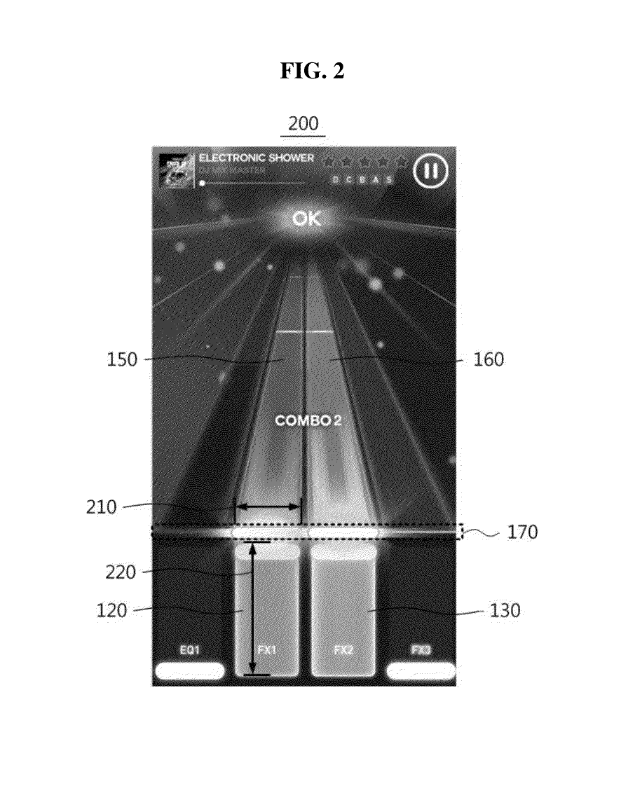

A game screen 200 of FIG. 2 displays an example in which sizes of the two note lines 150 and 160 are changed according to an input of the user when the two note lines 150 and 160 pass through the determination region 170.

For example, the game system may determine success or accuracy in an input of the user according to a size or direction of an input interface when the note or note line (e.g., the two note lines 150 and 160) passes through the determination region 170.

The game screen 200 displays an example in which the game system compares widths of the note lines 150 and 160 with sizes of the input interfaces 120 and 130 and determines success in the input of the user. In this case, it may be known that each of the note lines 150 and 160 fully occupies corresponding one of second and third tracks in width and each of the input interfaces 120 and 130 has a maximum value in size. For example, when the note line 150 fully occupies the second track in width (e.g., area 210), the input interface 120 may have a maximum value in size (e.g., height 220).

In other words, in the rhythm game service according to an example embodiment of the inventive concepts, a game may progress in such a way that the user adjusts a size of an input interface of a corresponding track according to a width of a provided note line.

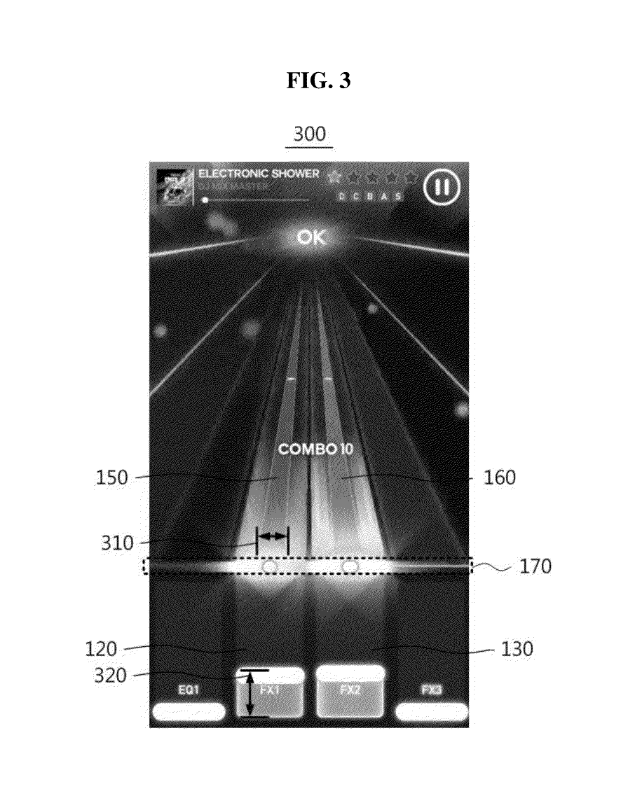

A game screen 300 of FIG. 3 displays an example in which as each of the note lines 150 and 160 becomes thinner and thinner in width, corresponding ones of the input interfaces 120 and 130 should be gradually decreased in size. For example, the game screen 300 displays an example in which as the note line 150 is decreased in width (e.g., area 310), the user reduces the input interface 120 in size (e.g., height 320).

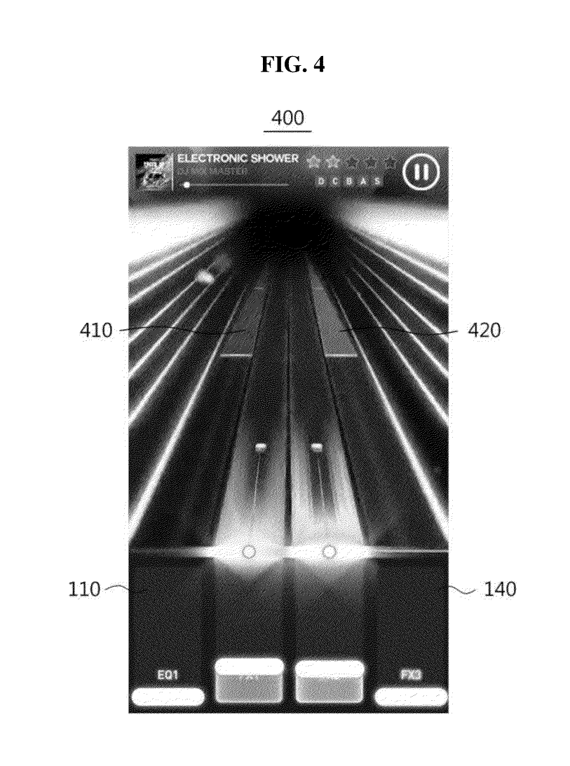

A game screen 400 of FIG. 4 displays an example in which each of new note lines 410 and 420 appears on corresponding ones of a first track and a 4^{th} track according to a rhythm game service in progress. The user may control each of input interfaces 110 and 140 in size for corresponding one of the note lines 410 and 420. In this case, when the note lines 410 and 420 pass through a determination region, the game system may compare sizes of the input interfaces 110 and 140, which are changed according to an input of the user, with widths of the note lines 410 and 420 and may determine whether the input of the user succeeds or accuracy of the input of the user.

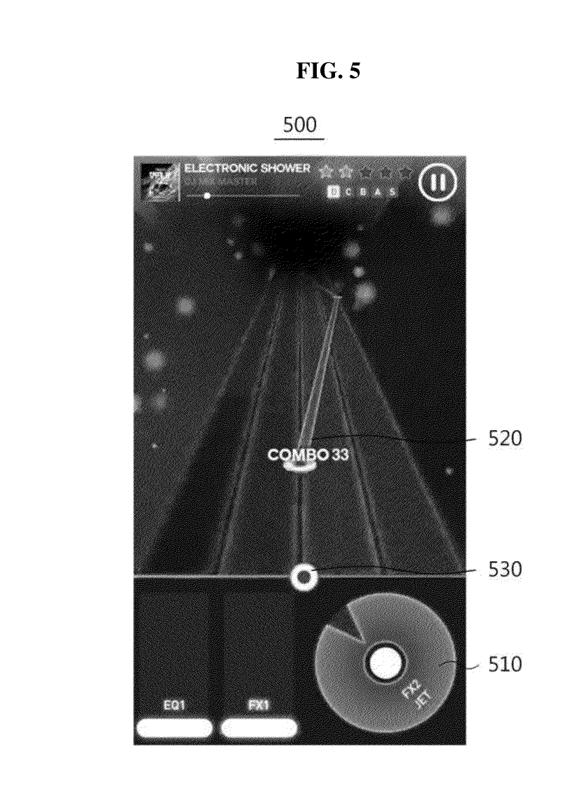

FIGS. 5 to 7 are drawings illustrating a game screen for displaying a game process which proceeds by controlling a direction of an input interface according to an example embodiment of the inventive concepts.

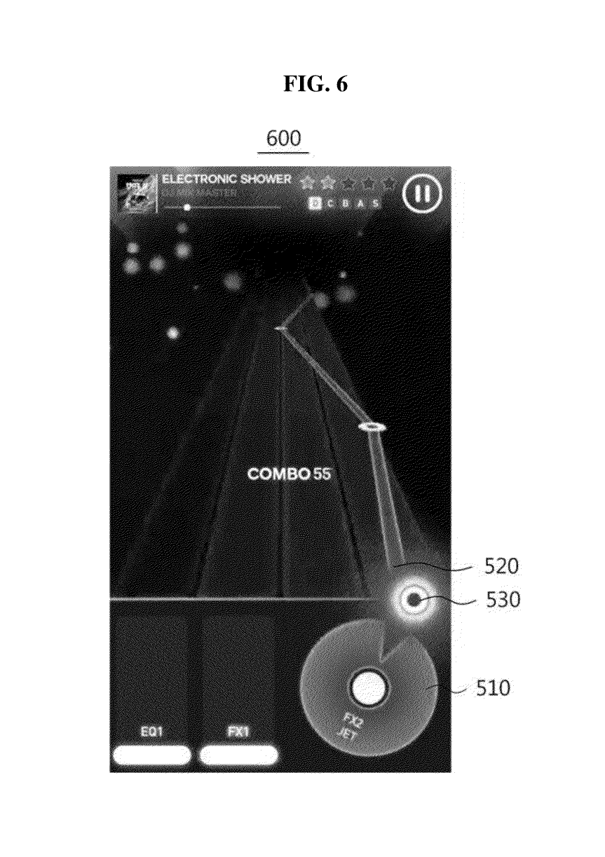

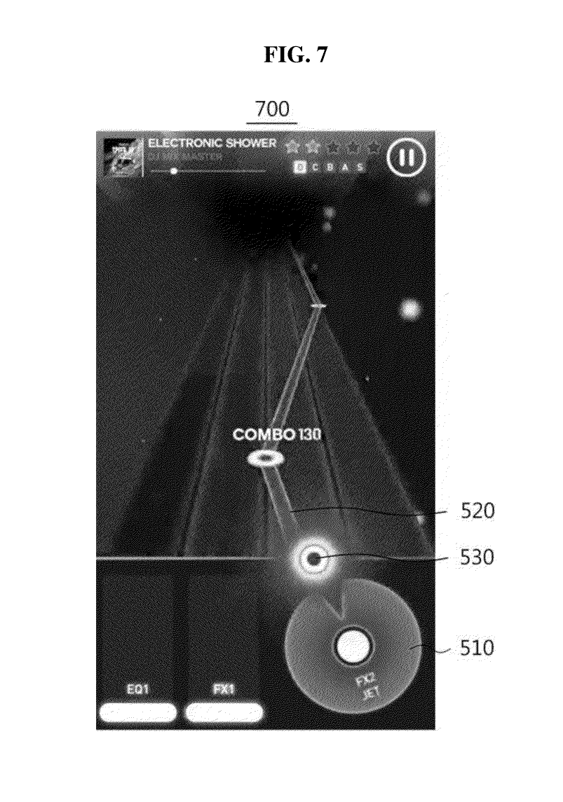

A game screen 500 of FIG. 5, a game screen 600 of FIG. 6, and a game screen 700 of FIG. 7 display an example in which input interfaces 130 and 140, described with reference to FIGS. 1 to 4, which are adjusted in size are changed to an input interface 510 indicating a direction. In this case, the game screen 500, the game screen 600, and the game screen 700 display an example in which a user changes a direction of the input interface 510 when a note line 520 in which a path moved towards a moving determination region is changed passes through the determination region. In this case, a location on the determination region according to a direction of the input interface 510 may be displayed through an object 530 on each of the game screens 500, 600, and 700.

In this case, a game system may compare a location of the note line 520 which passes through the determination region with a direction of the input interface 510 and may determine whether an input of the user succeeds or accuracy of the input of the user. For example, the game system may compare a location on the determination region according to a direction of the input interface with a location where the note line 520 passes through the determination region and may determine whether an input of the user succeeds or accuracy of the input of the user.

As shown in the game screen 500, the game screen 600, and the game screen 700, the note line 520 may include at least a partial interval where a path moving towards the determination region is continuously changed.

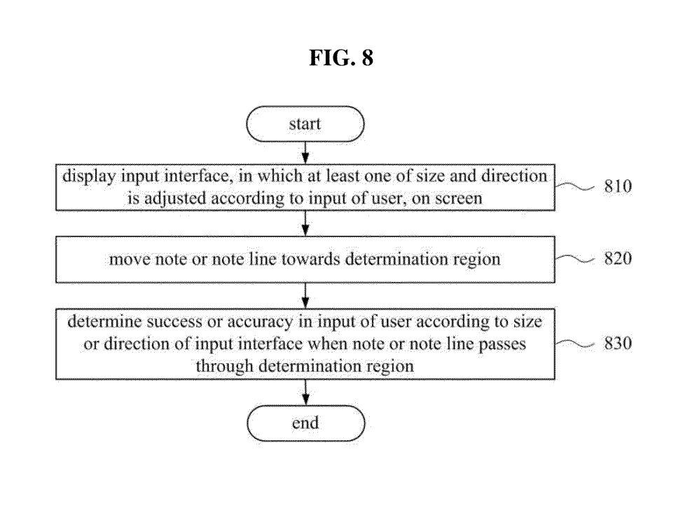

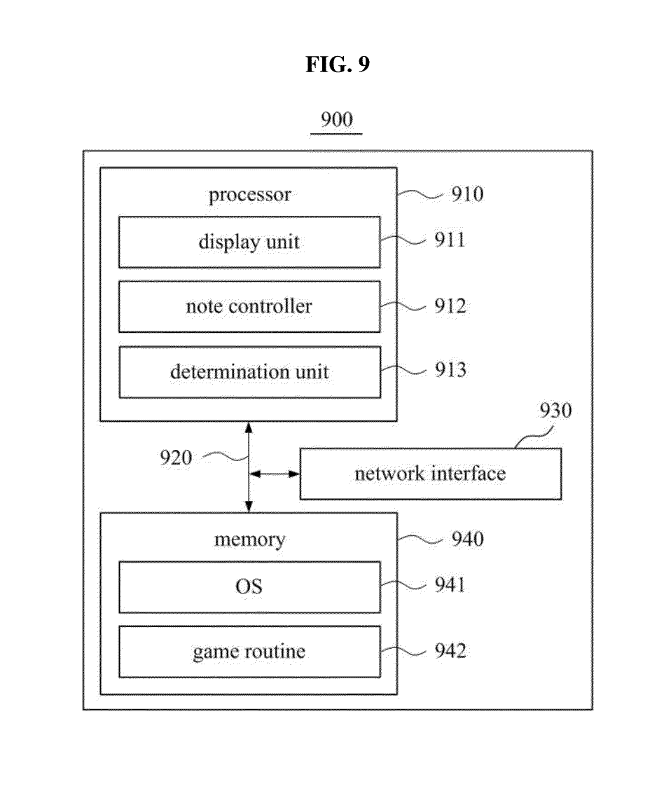

FIG. 8 is a flowchart illustrating an operation of a game method according to an example embodiment of the inventive concepts. FIG. 9 is a block diagram illustrating a configuration of a game system according to an example embodiment of the inventive concepts.

A game system 900 according to an example embodiment of the inventive concepts may correspond to the game system described above. As shown in FIG. 9, the game system 900 may include a processor 910, a bus 920, a network interface 930, a memory 940, and a touch screen 960. The memory 940 may include an operating system (OS) 941 and a game routine 942. The processor 910 may be configured to include (e.g., by executing computer readable instructions stored in the memory 940) a display controller 911, a note controller 912, and a determination unit 913. In other example embodiments of the inventive concepts, the game system 900 may include more elements than that of FIG. 9. For example, the game system 900 may further include other elements such as a keyboard and/or a transceiver.

The memory 940 may be a computer-readable medium and may include permanent mass storage devices such as a random access memory (RAM), a read only memory (ROM), and a disc drive. Also, the memory 940 may store program codes for the OS 941 and the game routine 942. These software elements may be loaded from a computer-readable medium which is independent of the memory 940 using a drive mechanism (not shown). This computer-readable medium may include a computer-readable medium (not shown) such as a floppy drive, a disc, a tape, a Digital Versatile Disc (DVD)/compact disc (CD)-ROM drive, and a memory card. In another example embodiment of the inventive concepts, software elements may be loaded into the memory 940 through the network interface 930 other than the computer-readable medium. For example, the game routine 942 may be loaded into the memory 940 according to programs installed by files provided from developers through a network.

The bus 920 may facilitate communication and data transmission between elements of the game system 900. The bus 920 may be configured using a high-speed serial bus, a parallel bus, a storage area network (SAN), and/or other proper communication technologies.

The network interface 930 may be a computer hardware element for connecting the game system 900 to a computer network. The network interface 930 may connect the game system 900 to a computer network through a wireless or wired connection.

The touch screen 960 may be driven by the processor 910 to display game screens such as shown in FIGS. 1-7, and to obtain the user input from displayed input interfaces through user touch (e.g., tap, swipe, etc.).

The processor 910 is configured as a special purpose machine by executing instructions of a computer program and thus perform arithmetic operations, logic operations, and an input-output operation of the game system 900. The instructions may be provided to the processor 910 through the bus 920 by the memory 940 or the network interface 930. The display controller 911, the note controller 912, and the determination unit 913 included in the processor 910 may be configured to execute program codes or instructions. These program codes or instructions may be stored in a recording device (e.g., the game routine 942) such as the memory 940.

In this case, the processor 910 configured as the display controller 911, the note controller 912, and the determination unit 913 may perform steps 810 to 840 of FIG. 8.

In step 810, the processor 910 may load program codes stored in at least one file of an application for a rhythm game or a rhythm game service to a memory (e.g., the memory 940). For example, the at least one file of the application may be provided from file distribution server for the rhythm game or the rhythm game service in a network and be installed the game system 900. When the application is executed, the processor 910 may load the program codes from the at least one file to memory.

In step 820, the display controller 911 may control a screen (e.g., the touch screen 960) to display an input interface, in which at least one of a size and a direction is adjusted according to an input of a user, on the screen of the game system 900. For example, the display controller 911 may execute a part of the program codes loaded in the memory to control the screen. Examples of game screens displaying these input interfaces are described with reference to FIGS. 1 to 7. The game system according to the above-described example embodiments may control a size of an input interface by changing a height of the input interface. However, the game system may also control a size of an input interface by changing a width of the input interface. Also, various modifications, such as a disk shape, an arrow shape, and a jog shuttle shape, are possible in an input interface which adjusts a direction.

In step 830, the note controller 912 may move a note or note line towards a determination region on the screen. For example, the note controller 912 may execute a part of the program codes loaded in the memory to move the note or note line. The movement may be according to pre-stored movement routines randomly selected by the note controller 912.

For one example, a note which is continuously changed in width while moving towards the determination region or a note line including a portion, which is continuously changed in width, may be used. The note controller 912 may control movement of the note or note line such that this note or note line is displayed on the screen while moving towards the determination region.

For another example, a note or note line including an interval where a path that moves towards a determination region is continuously changed may be used. In this case, the note controller 912 may control movement of the note or note line such that this note or note line is displayed on the screen while moving towards the determination region.

In step 840, the determination unit 913 may determine success or accuracy in an input of the user (e.g., an input from the touch screen 960) according to a size or direction of an input interface when the note or note line passes through the determination region. For example, the determination unit 913 may execute a part of the program codes loaded in the memory to determine success or accuracy in an input of the user.

According to an example embodiment of the inventive concepts, the determination unit 913 may compare a width of the note or note line which passes through the determination region with a size of an input interface and may determine success or accuracy in an input of the user. For one example, the determination unit 913 may guide the user to relatively decrease or increase a size of an input interface to match a width of an input interface to the width of the note. In this case, when the width of the note is matched with the size of the input interface, the determination unit 912 may determine that the input of the user succeeds or may compute accuracy of the input of the user according to a degree or percentage that the interface matched the note. This degree or percentage of matching may be converted to a score and accumulated by the determination unit 913 and displayed by the display controller 911. For another example, the display controller 911 may control the screen to display an object, which is adjusted in width in response to a size of an input interface, on a determination region. In this case, the determination unit 913 may compare a width of a note or note line which passes through the determination region with a width of the object displayed on the determination region and may determine success or accuracy in an input of the user.

According to another example embodiment of the inventive concepts, in step S840, the determination unit 913 may compare a location where a note or note line passes through a determination region with a direction adjusted by an input interface and may determine success or accuracy in an input of the user. For example, when a direction indicated by an input interface according to an input of the user indicates the location where the note or note line passes through the determination region, the determination unit 913 may determine that the input of the user succeeds. Alternatively, the determination unit 913 may compute accuracy in which the direction indicated by the input interface indicates the location where the note or note line passes through the determination region.

In another example embodiment of the inventive concepts, the game method may further include a step (not shown) of controlling the screen to display an object in which a location move on a determination region in response to a direction indicated by an input interface, in addition to steps 810 to 840 described with reference to FIG. 8. In this case, the determination unit 913 may compare a location where a note or note line passes through the determination region with the location where the object is displayed on the determination region and may determine whether an input of the user succeeds or accuracy of the input of the user.

Also, the display controller 911 may control the screen to display input interfaces on a display, the input interfaces corresponding respectively to a plurality of channels through which a note or note line moves. For example, FIG. 4 illustrates an example in which four input interfaces are displayed for four channels. In this case, at least one of a size or a direction of each of input interfaces corresponding respectively to the plurality of channels may be adjusted simultaneously or at intervals of a certain time according to a note or note line which moves through the plurality of channels.

The game system 900 may be implemented with a computer including a touch screen (e.g., an input from the touch screen 960). In this case, in step 820, the display controller 911 may control the touch screen to adjust a size or direction of an input interface in response to at least one of a touch and drag event or a swipe event which occurs on the input interface on the touch screen 960.

For one example, a user may touch and drag regions, where input interfaces 110 to 140 are displayed, with his or her fingers on a game screen 100 of FIG. 1. When the user touches and drags the region, where the input interface 120 is displayed, to an upper side of the game screen 100 with his or her fingers, a size of the input interface 120 may be increased. When the user touches and drags the region, where the input interface 120 is displayed, to a lower side of the game screen 100 with his or her fingers, a size of the input interface 120 may be decreased.

For another example, the user may touch and drag a region, where an input interface 510 is displayed, with his or her fingers on a game screen 500 of FIG. 5. When the user touches and drags the region, where the input interface 510 is displayed, in a left or right direction of the game screen 500 with his or her fingers, a direction of the input interface 510 may be changed to the left or right direction.

A change degree in size or direction may be determined according to a drag degree in a touch and drag event. In case of a swipe event, input interfaces may be similarly changed and adjusted in size or direction.

For example, the display controller 911 may control the screen to display a slide object corresponding to an input interface on the screen. the screen may be the touch screen. The display controller 911 may control the touch screen to display the slide object on the screen to be increased or decreased in size according to an event which occurs for the slide object. In this case, as a size of the slide object is increased, a size of an input interface may be increased. As a size of the slide object is decreased, a size of the input interface may be decreased.

Also, the display controller 911 may control the screen to display a jog shuttle object corresponding to an input interface on the touch screen. The display controller 911 may control the screen to display the jog shuttle object on the screen to rotate according to an event which occurs for the jog shuttle object. In this case, a direction indicated by an input interface may be determined through a direction determined according to the rotation of the jog shuttle object.

As such, according to an example embodiment of the inventive concepts, the game system may provide a rhythm game service in such a way as to compare an adjusted size or direction of an input interface with a width of a note or note line or a location where the note or note line passes through a determination region when a user adjusts the size or direction of the input interface in response to the note or note line in which the width or the location where passing through the determination region is changed and to determine success or accuracy in an input of the user.

The foregoing devices may be realized by hardware elements, at least one processor executing software elements, and/or combinations thereof. For example, the devices and components illustrated in the example embodiments of the inventive concepts may be implemented by processing circuitry such as a computer, a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described example embodiments of the inventive concepts may be implemented with program instructions which may be executed by various processing circuitry and may be recorded in computer-readable media. The computer-readable media may also include, alone or in combination with the program instructions, data files, data structures, and the like. The program instructions recorded in the media may be designed and configured specially for the example embodiments of the inventive concepts or be known and available to those skilled in computer software. Computer-readable media may include magnetic media such as hard disks, floppy disks, and magnetic tape; optical media such as CD ROM disks and DVDs; magneto-optical media such as floptical disks; and hardware devices which are specially configured to store and perform program instructions, such as a read-only memory (ROM), a random access memory (RAM), a flash memory, and the like. Program instructions may include both machine codes, such as produced by a compiler, and higher-level language codes which may be executed by the computer using an interpreter. The described hardware devices may be configured to as one or more modules or units to perform the operations of the above-described example embodiments of the inventive concepts, or vice versa.

While a few example embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A game method in a game system implemented with a computer, the method comprising:
controlling, by the processor, a screen to display an input interface, in which at least one of a size or a direction is adjusted according to an input of a user, on the screen of the computer;
moving, by the processor, a note or note line towards a determination region on the screen; and
determining, by the processor, success or accuracy in the input of the user according to a size or a direction of the input interface when the note or note line passes through the determination region.

2. The method of claim 1, wherein the determining success or accuracy in the input of the user comprises:
comparing a width of the note or note line which passes through the determination region with a size of the input interface.

3. The method of claim 2, wherein the note or note line has at least a part which is continuously changed in width while moving towards the determination region.

4. The method of claim 1, further comprising:
controlling the screen to display an object, which is adjusted in width in response to a size of the input interface, on the determination region,
wherein the determining success or accuracy in the input of the user includes,
comparing a width of the note or note line which passes through the determination region with a width of the object displayed on the determination region.

5. The method of claim 1, wherein the determining success or accuracy in the input of the user comprises:
comparing a location where the note or note line passes through the determination region with a direction indicated by the input interface.

6. The method of claim 5, wherein the note or note line has at least a part in which a path moved towards the determination region is continuously changed.

7. The method of claim 1, further comprising:
controlling the screen to display an object in which a location moves on the determination region in response to a direction indicated by the input interface,
wherein the determining success or accuracy in the input of the user includes,
comparing a location where the note or note line passes through the determination region with a location where the object is displayed on the determination region.

8. The method of claim 1, wherein the controlling a screen comprises:
controlling the screen to display input interfaces corresponding respectively to a plurality of channels through which the note or note line moves, and
wherein at least one of a size or a direction of each of the input interfaces corresponding respectively to the plurality of channels is adjusted simultaneously or at intervals of a certain time according to the note or note line which moves through the plurality of channels.

9. The method of claim 1, wherein the controlling a screen comprises:
controlling the screen to adjust a size or a direction of the input interface through at least one of a touch and drag event or a swipe event which occurs on the input interface on the screen, the screen being a touch screen.

10. The method of claim 1, wherein the controlling a screen comprises:
controlling the screen to display a size of the input interface to be increased or decreased according to a direction of a slide event, which occurs on the input interface on the screen, the screen being a touch screen.

11. The method of claim 1, wherein the controlling a screen comprises:
controlling the screen to display a slide object, corresponding to the input interface on the screen and displaying a size of the slide object to be increased or decreased according to an event, which occurs on the slide object, on the screen, the screen being a touch screen
wherein a size of the input interface is increased as the size of the slide object is increased, and
wherein the size of the input interface is decreased as the size of the slide object is decreased.

12. The method of claim 1, wherein the controlling a screen comprises:
controlling the screen to display a jog shuttle object, corresponding to the input interface on the screen and displaying the jog shuttle object to rotate according to an event, which occurs on the jog shuttle object, on the screen, the screen being a touch screen, and
wherein a direction indicated by the input interface is determined through a direction determined according to rotation of the jog shuttle object.

13. A computer-readable medium having embodied thereon instructions that when executed by a computer cause the computer to perform the method of claim 1.

14. A game system implemented with a computer, the system comprising:
at least one processor configured to execute computer readable instructions to,
control a screen to display an input interface, in which at least one of a size or a direction is adjusted according to an input of a user, on the screen of the computer;
move a note or note line towards a determination region on the screen; and
determine success or accuracy in the input of the user according to a size or a direction of the input interface when the note or note line passes through the determination region.

15. The system of claim 14, wherein in performing the determination, the processor compares a width of the note or note line which passes through the determination region with a size of the input interface.

16. The system of claim 14, wherein in performing the controlling, the processor controls the screen to display an object, which is adjusted in width in response to a size of the input interface, on the determination region, and
wherein in performing the determination, the processor compares a width of the note or note line which passes through the determination region with a width of the object displayed on the determination region.

17. The system of claim 14, wherein in performing the determination, the processor compares a location where the note or note line passes through the determination region with a direction indicated by the input interface.

18. The system of claim 14, wherein in performing the controlling, the processor controls the screen to display an object in which a location moves on the determination region in response to a direction indicated by the input interface, and
wherein in performing the determination, the processor compares a location where the note or note line passes through the determination region with a location where the object is displayed on the determination region an determines the success or accuracy in the input of the user.

19. The system of claim 14, wherein in performing the controlling, the processor controls the screen to adjust a size or a direction of the input interface through at least one of a touch and drag event or a swipe event which occurs on the input interface on a touch screen incorporated in the game system.

20. The system of claim 14, wherein in performing the controlling, the processor controls the screen to display a slide object corresponding to the input interface on a touch screen incorporated in the game system, or a jog shuttle screen on the touch screen and controls the screen to display a size of the slide object to be increased or decreased according to an event, which occurs on the slide object, on the touch screen, or controls the screen to display the jog shuttle object to rotate according to an event, which occurs on the jog shuttle object, on the touch screen, and
wherein in performing the controlling, the processor controls the screen to increase or decrease a size of the input interface as the size of the slide object is increased or decreased, or wherein in performing the controlling, the processor determines a direction indicated by the input interface according to rotation of the jog shuttle object.
